(19) United States
(12) Patent Application Publication
(10) Pub. No.: US 2018/0218287 A1
(43) Pub. Date: Aug. 2, 2018

(54) DETERMINING PERFORMANCE OF A MACHINE-LEARNING MODEL BASED ON AGGREGATION OF FINER-GRAIN NORMALIZED PERFORMANCE METRICS

(71) Applicant: Facebook, Inc., Menlo Park, CA (US)

(72) Inventors: Zhuang Wang, San Carlos, CA (US); Robert Oliver Burns Zeldin, Los Altos, CA (US); Sushma Nagesh Bannur, Cupertino, CA (US); Rami Mahdi, San Mateo, CA (US); Rubinder Singh Sethi, San Francisco, CA (US); Shyamsundar Rajaram, San Francisco, CA (US); Leon R. Cho, Santa Clara, CA (US)

(21) Appl. No.: 15/421,438

(22) Filed: Feb. 1, 2017

(51) Int. Cl. G06N 99/00; G06Q 30/02; G06N 5/04

(52) U.S. Cl. CPC G06N 99/005; G06N 5/04; G06Q 30/0201

(57) ABSTRACT

An online system receives content items, for example, from content providers and sends the content items to users. The online system uses machine-learning models for predicting whether a user is likely to interact with a content item. The online system uses stored user interactions to measure the model performance to determine whether the model can be used online. The online system determines a baseline model using stored user interactions. The online system determines whether the machine-learning model performs better than the baseline model or worse for each content provider. The online system determines whether to approve the model for online use based on an aggregate normalized performance metric, for example, a metric representing the fraction of content providers for which the model performs better than the baseline. If the online system determines to reject the model, the online system retrains the model.

### BACKGROUND

This disclosure relates in general to evaluating performance of machine-learning models and in particular to evaluating performance of a model for predicting a score value associated with an expected user action in response to presenting the user with a content item.

Online systems, for example, social networking systems, provide content items to users that are expected to interact with the content items. The content items may be generated by other users of the online system or received from content providers. Online systems may use a model for predicting score values associated with predicted user actions performed by users presented with a content item. Online systems evaluate the performance of the model, for example, for determining how accurately the model predicts the score value. Conventional techniques for evaluating models often fail to accurately evaluate the model for specific content providers. As a result, the online system may use poor models for determining whether to send a content item to a user or not. If the model performs poorly, the online system sends content items to users that are not interested in the content items, thereby wasting impression opportunity, network bandwidth and providing poor user experience.

### SUMMARY

An online system optimizes a machine-learning model to accurately predict a number of interactions to be associated with a given content provider. The online system receives one or more content items from one or more content providers and iteratively trains a machine-learning model to optimize a models performance in terms of the accuracy of the models predictions. In various embodiments, the online system provides the content item to one or more users of the online system and receives a log of user interactions with the content item. The online system determines a baseline performance metric. The online system determines a normalized performance metric associated with the model value for each of a plurality of content providers. In one embodiment, the machine-learning model is a binary classification model and the normalized performance metric for a content provider can be a normalized entropy. In another embodiment, the machine-learning model is a regression model and the normalized performance metric may be R-squared metric.

The online system determines an aggregate normalized performance metric based on the normalized performance metric values for individual content providers. For example, the aggregate normalized performance metric value may measure the percentage or fraction of content providers for which the model performs better than baseline. As another example, the aggregate normalized performance metric value may measure an amount of aggregate improvement compared to the baseline for all or a subset of content providers. Responsive to the aggregate normalized performance metric exceeding a threshold value indicative of good performance of the model, the online system approves the model for use by the online system. On the other hand, if the normalized performance metric is below a threshold value, the online system retrains the model iteratively until the aggregate normalized performance metric improves.

### BRIEF DESCRIPTION OF THE DRAWINGS

FIG. 1 shows a system environment illustrating the interaction between an online system, a content provider, and a user device in accordance with an embodiment.

FIG. 2 shows a block diagram of an online system in accordance with an embodiment.

FIG. 3 is a block diagram of the optimization module shown in conjunction with FIG. 2.

FIG. 4A illustrates a relative percentage, in terms of a number of content providers in a population of content providers in accordance with an embodiment of the invention.

FIG. 4B illustrates a mapping table generated by ranking the population of content providers illustrated in FIG. 4A by a normalized performance metric, for example, a normalized entropy in accordance with an embodiment.

FIG. 4C illustrates a graph of the performance of the distribution of the normalized performance metric illustrated in FIG. 4B, in accordance with an embodiment.

FIG. 5 is a flowchart illustrating the process executed by an online system for using a machine-learning model in accordance with an embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### System Environment

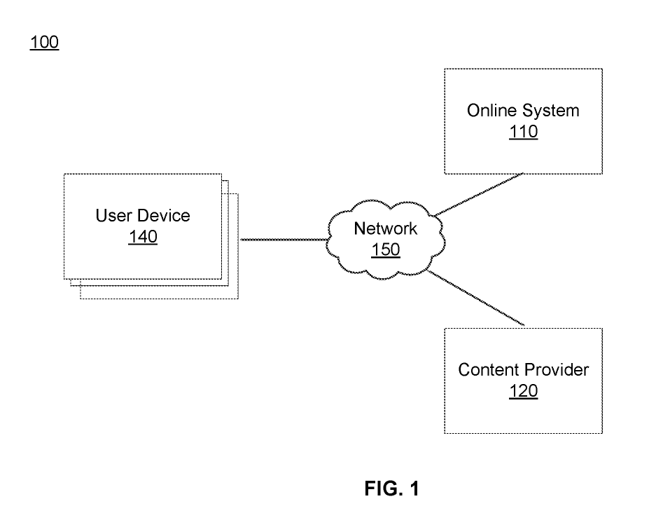

FIG. 1 shows a system environment 100 illustrating the interactions between an online system 110, a content provider 120, and one or more user devices 140 via a network 150, in accordance with an embodiment. In alternative configurations, different and/or additional components may be included in the system environment 100. For example, typically there are a large number of user devices 140 and content providers 120 interacting with the online system 110. As used herein, the term user refers to users of the online system 110.

The online system 110 provides certain types of services to users via user devices 140. As illustrated in FIG. 1, the online system 110 provides content to one or more user devices 140 via the network 150. The online system 110 may provide other services in addition to providing content. For example, the online system 110 may enable users to interact with other users of the online system 110, share content, and post comments. In additional embodiments, the online system 110 may enable users to make purchases, interact with content provided by a content provider 120. In an embodiment, the online system 110 is a social networking system and allows users to establish connections with other users of the social networking system, interact with the connections of the user, receive information describing various actions performed by the connections of the user, and interact with content provided by the content provider 120 on the social networking system via network 150.

The online system 110 receives requests from one or more user devices 140 and sends web pages to the user devices 140 via the network 150 in response. Here each of the one or more user devices 140 is associated with a user of the online system 110 and enables interactions between the user and the online system 110. The online system 110 may also receive one or more content items from one or more content providers 120. The received content items may comprise a text message, a picture, a hyperlink, a video, an audio file, or some combination thereof. The online system 110 may include the received one or more content items in web pages sent to the user device 140. For example, the online system 110 may present a newsfeed to the user device 140 where the newsfeed includes the one or more received content items. In some embodiments, the content items received by the online system 110 from the content provider 120 may be promotional content or sponsored content. For example, the received content items may be an advertisement. Accordingly, a content provider 120 provides remuneration to the online system 110 for publishing the one or more content items associated with the content provider 120.

The user devices 140 are one or more computing devices capable of receiving user input as well as transmitting and/or receiving data via the network 150. A user device is also referred to herein as a client device. The user device 140 may be associated with a user of the online system 110. In one embodiment, a user device 140 is a conventional computer system, such as a desktop or a laptop computer. Alternatively, a user device 140 may be a device having computer functionality, such as a personal digital assistant (PDA), a mobile telephone, a smartphone or another suitable device. A user device 140 is configured to communicate via the network 150. In one embodiment, a user device 140 may execute an application allowing a user of the user device 140 to interact with the online system 110. For example, a user device 140 executes a browser application to enable interaction between the user device 140 and the online system 110 via the network 150. In another embodiment, a user device 140 interacts with the online system 110 through an application programming interface (API) or a software development kit (SDK) running on a native operating system of the user device 140, such as IOS® or ANDROID™.

The user device 140 is configured to communicate with the online system 110 via the network 150, which may comprise any combination of local area and/or wide area networks, using both wired and/or wireless communication systems. In one embodiment, the network 150 uses standard communications technologies and/or protocols. For example, the network 150 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 150 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 150 may be represented using any suitable format, such as hypertext markup language (HTML) or extensible markup language (XML). In some embodiments, all or some of the communication links of the network 150 may be encrypted using any suitable technique or techniques.

In various embodiments a user associated with a user device 140 interacts with the online system 110 via the user device 140. Interactions between a user associated with a user device 140 and the received one or more content items may include a click, a like, and a share with other users of the online system 110 connected to the user via the online system 110. The online system 110 configures a web page for sending to the user device 140. The online system 110 configures the web page such that a portion of the web page is used for providing the information requested by the user or for receiving user interactions specific to the features offered by the online system 110. The online system 110 configures the web page such that at least a portion of the web page is available for presenting one or more content items received from a third party such as the content provider 140. The online system 110 may include a link to the content item in the web page for allowing the user to access the content item using the link.

Users of the online system 110 provide value to the content provider 140 by interacting with one or more content item associated with the content provider 140. For example, a user making frequent purchases via the content provider 140 may be considered more valuable by the content provider 140. Thus, the content provider 140 may be more interested in targeting some viewers of the online system 110 with content than other users of the online system 110. For example, the content provider 140 may determine that users with certain demographics (e.g., within the age group 25-30, gender, and ethnicity) are more likely to interact with the content provided by a content provider 140. Accordingly, the content provider 140 may be more interested in targeting these users of the online system 110 with content items. Here, the online system 110 additionally generates and trains one or more machine-learning (ML) models to aid a content provider 140 in gaining a better understanding into how users of the online system 110 may react with a content item. Thus, the online system 110 trains a machine-learning model to help the content provider 140 optimize a content item to maximize its true business value.

### System Architecture

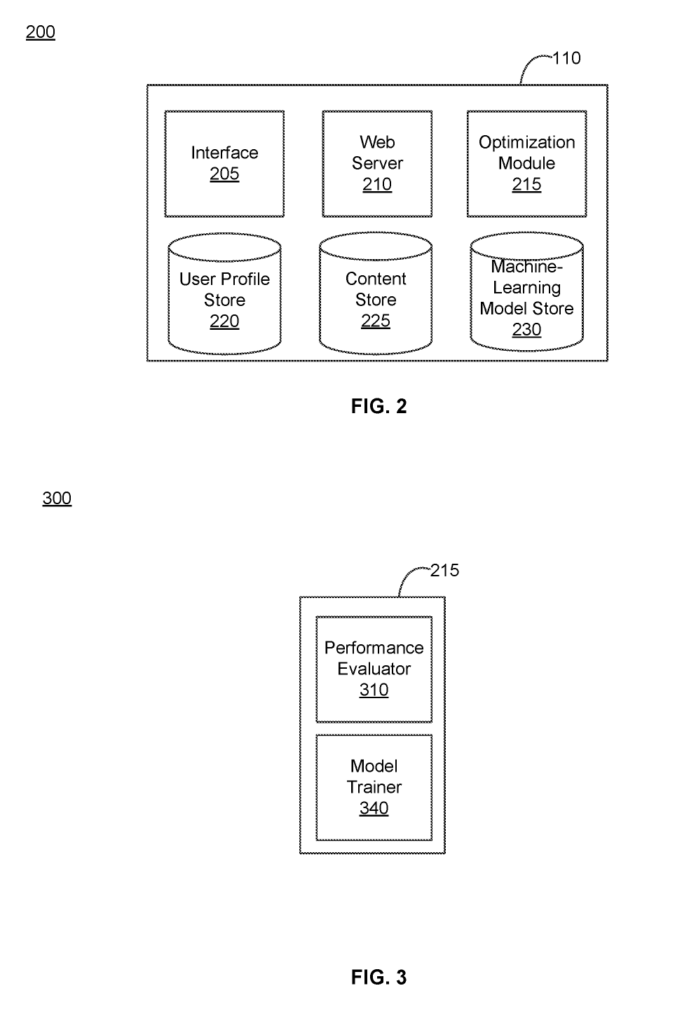

FIG. 2 illustrates a block diagram 200 of the online system 110. As depicted in FIG. 2, online system 110 comprises an interface 205, a webserver 210, an optimization module 215, a user profile store 220, a content store 225, and a machine-learning model store 230. In various embodiments, the online system 110 may include additional, fewer, or different components. Conventional components such as network interfaces, security functions, load balancers, failover servers, management and network operations consoles, and the like are not shown so as to not obscure the details of the system architectures.

The user profile store 220 stores information describing one or more users of the online system 110. In various embodiments, the user profile store 220 stores information about a user provided by either: users of the online system 110 or by the content provider 140. The user profile store 220 may contain demographic information associated with a user of the online system 110 (e.g., age, ethnicity, income, etc.). Examples of information stored in a user profile include biographic, demographic, and other types of descriptive information, such as work experience, educational history, gender, hobbies or preferences, location and the like. The user profile store 220 may also store a user name, a location, and an email address associated with the user. In some embodiments, the information stored in the user profile store 220 includes one or more interactions between the user and a content item associated with a content provider 140. In one or more embodiments, the user profile store 220 also stores interactions between a user of the online system 110 and one or more content items both on and off the online system 110. For example, the user profile store 220 stores one or more clicks, likes, shares, and comments associated with content items a user has interacted with. In other embodiments, interactions also include interactions associated with a mobile application running on a user device 130. For example, an interaction may be mobile application install event (app install), an application uninstall event (app uninstall), application open (app open), application close (app close), or other event associated with the application. The content stored in the user profile store 220 may include text, images, videos, audio, or a combination of various media types. In still other embodiments, a content item is a game or a video and the interaction type includes at least one of: the length of time a user of the online system played the game or watched the video.

The web server 210 receives requests from user devices 140 and processes the received requests by configuring a web page for sending to the requesting user device 140. The web server 225 includes content from content store 225 in the web page. The web server 210 sends the configured web page for presentation via the network 150 to the user device 140. The user device 140 receives the web page and renders the web page for presentation via a display screen of the user device 140.

The interface 205 allows the online system 110 to interact with external systems, for example, content provider 120 and a user device 140. The interface 205 imports data from content provider 120 or exports data to the content provider 120. For example, the interface 205 receives content items from the content provider 120. For example, the interface 205 presents an interface to a content provider 120 to upload one or more content items for sending to one or more user devices 140. The interface 205 may additionally enable a content provider 120 specify one or more interaction types to associate with the uploaded content. For example, a content provider 120 may specify that a content item 120 should be associated with clicks, or shares. In another example, the content provider 120 may specify an interaction type associated with an app event (e.g., app open, app close, app install, or app uninstall). In one embodiment the interface 205 is a graphical user interface (GUI) configured to receive one or more content items and one or more preferences from a content provider 120. In other embodiments, the interface 205 is configured to receive a Hypertext Transfer Protocol (HTTP) request comprising one or more content items from a content provider 120 (e.g., POST or GET).

The interface 205 assigns each of the one or more received content items a unique contentID. In various embodiments, the interface 205 stores the one or more received content items in the content store 225 as a <key, value> pair. Here, the key is the providerID associated with a content provider 120. The value is the contentID associated with the uploaded content item. In other embodiments, a content item stored in the content store 225 is stored as <key, value1, value2> where value1 is the contentID and value2 corresponds to a type of interaction specified by a content provider 120 as described above.

The interface 205 may present a content provider 120 metadata and statistical information associated with a content item. That is, the interface 205 allows a content provider 120 to gain insight into the performance of a content item. Example information presented to a content provider 120 by the interface 205 includes a combination of demographic and statistical data. For example, information presented to a content provider 120 may indicate that 37% of male users between the ages of 25-37 “liked” a video about kittens posted by PURINAONE. In another example, the information presented to a content provider 120 may indicate the distribution of click through rates (CTR) associated with a particular content item. In still other embodiments, the interface 205 may provide a machine-learning model based prediction of the performance of an uploaded content item over a variety of demographic ranges (e.g., expected CTR of female users between the ages of 18-22).

The optimization module 215 retrieves a stored machine-learning model from the machine-learning model store 230 and iteratively optimizes model performance in terms of a normalized performance metric (NPM) for a single content provider 120. The optimization module is used determine the effectiveness of a machine-learning model in terms of its ability to predict the number of user interactions. For example in the advertising domain where the content item is an advertisement and the model optimization module 215 determines how much a machine-learning model out-performs a historical CTR across all user interactions with the content item given a particular advertisement. Here responsive to the NPM associated with machine-learning model indicating a performance greater than a threshold value, the optimization module 215 selects the optimized machine-learning model for use. Alternatively, if the optimization module determines that the NPM associated with the model indicates that the model performs worse than the threshold value; the optimization module 230 retrieves the machine-learning model to be trained again. In other embodiments, the model optimization module 215 determines an aggregate NPM to be used to optimize the machine-learning model. The aggregate NPM is based on the NPMs of each of a subset of the plurality of content providers 120. Here, responsive to an indication that the aggregate NPM performs well for most advertisers, the optimization module 215 selects the optimized machine-learning model for user. In other embodiments, the machine-learning model is configured to perform a binary classification. In still other embodiments, the machine-learning model is a regression based model. The optimization module is further described below in conjunction with FIG. 3.

### Evaluation of Machine-learning Model

FIG. 3 is a block diagram of an optimization module 215, in accordance with an embodiment. In FIG. 3, the optimization module 215 comprises a performance evaluator 310 and a model trainer 340.

The performance evaluator 310 determines a NPM associated with the retrieved machine-learning model. The determined NPM is based a model performance metric and a baseline performance metric. The baseline performance metric (BPM) is the likelihood of a user of the online system 110 interacting with a given content item associated with the content provider 120. Here, the likelihood of a user interaction is based on statistical information determined from all past user interactions of a particular interaction type. Said another way, the BPM is indicative of the aggregate performance of all the content items associated with a given a particular interaction type. For example, if a user of the online system 110 with certain demographics (e.g., with a certain age group, certain gender, and ethnicity) is shown a content item, the BPM is the probability that the user will interact with a content item associated with the content provider 120 based on historical data. In the above example, if the interaction is a CTR and the historical CTR for all users is 1%, the baseline performance metric is 1%.

The NPM determined by the performance evaluator 310 is a log-loss measure of the accuracy with which the machine-learning model can predict a user interaction with a content item associated with a given content provider 120. In one example embodiment, in order to determine the log-loss measure, the performance evaluator 310 first calculates a log-loss associated with a given machine-learning model by calculating a sum of the logarithm of the predicted probability of correctly predicting an interaction of a user interaction with the content item over the number of online system users to whom the content item was presented and the types of interactions associated with the content item. Here, the resultant sum of probabilities is normalized by the total number of online system users to whom the content item was presented. The calculation of a log-loss error provides extreme punishments for being both confident and wrong. Typically, the value of the log-loss determined by the performance evaluator 310 quantifies the accuracy of the machine-learning model by penalizing false classifications. That is, the determined log-loss measure indicates the unpredictability of a user interaction. For example, a machine-learning model which was able to perfectly predict the interactions with a particular content item, would have a log-loss value of exactly 0. Conversely, the larger the error rate in the machine-learning model's ability to predict interactions with a content item, the larger the determined log-loss value. In general, the log-loss measure delineates the entropy inherent within the distribution of interactions with a particular content item across users of the online system 110. Thus, by minimizing the entropy of a machine-learning model, one maximizes the accuracy of the machine-learning model.

In one or more embodiments, the NPM associated with a machine-learning model by the performance evaluator 310 is a measure of normalized entropy (NE). The calculated NE is defined a ratio of the calculated cross entropy to the BPM and serves as an indicator of the performance of the machine-learning model. For example, a low value of NE (e.g., NE<1) indicates that the machine-learning model performs better than the baseline performance metric; an NE value equal to one (e.g., NE=1) indicates that the machine-learning model is performing the same as the baseline performance metric; and an NE value greater than 1 (e.g., NE>1) implies that the machine-learning model is performing worse than the baseline performance metric. In other embodiments the normalized entropy is measure of the root-mean squared error.

In still other embodiments where the machine-learning model is a regression-based model, the normalized performance metric is an R-squared coefficient. The R-squared coefficient is associated with the machine-learning model's ability to predict a user's total spending. For example, an R-squared value close to 1 indicates that the machine-learning model is able to predict future a user's total spending well. Alternatively, in the example above, an R-squared value close to zero indicates that the model is not able to predict a user's future spending. A machine-learning model's prediction of the spending associated with a user in response to the user viewing a content item is based on the number or type of interactions with a content item performed by the user.

The model trainer 340 trains the model using stored user interactions. In an embodiment, the model trainer 340 extracts feature vectors describing user profile data, content items, content provider, and so on. In an embodiment, the machine-learning model receives input features describing the content items including metadata describing the content item such as a topic described in the content item, an image of the content item, an object described or shown in the content item, topics described in the text of the content item (for example, text explicitly included in the content item or text obtained by transcribing an audio of the content item), and so on. The machine-learning model may receive input features describing the user profile of a user, for example, a gender of the user, an age of the user, social information describing the user including the connections of the user in a social networking system, user interactions performed by the user via the online system, and so on. The machine-learning model may receive input features describing the content provider, for example, features describing the type of content provided by the content provider, any products or services offered by the content provider, and so on.

In an embodiment, users provide the training sets set by manually identifying content items and demographic criteria that represent high scores and demographic criteria that represent low scores. In another embodiment, the model trainer 340 extracts training sets from past user interactions. The past user interactions represent user interactions that were performed by users responsive to being presented with content items including different types of features. If a past interaction indicates that a user interacted with a content item responsive to being presented with the content item, the model trainer 340 uses the content item as a positive training set. If a stored interaction indicates that a user did not interact with a content item responsive to being presented with the content item, the model trainer 340 uses the content item as a negative training set.

The model trainer 340 uses machine-learning to train the machine-learning model with the feature vectors of the positive training set and the negative training set serving as the inputs. Different machine-learning techniques-such as linear support vector machine (linear SVM), boosting for other algorithms (e.g., AdaBoost), neural networks, logistic regression, naïve Bayes, memory-based learning, random forests, bagged trees, decision trees, boosted trees, or boosted stumps-may be used in different embodiments. The model trainer 340, when applied to the feature vector extracted from a content item, outputs an indication of whether the content item has the property in question, such as a Boolean yes/no estimate, or a scalar value representing a probability.

In some embodiments, a validation set is formed of additional features, other than those in the training sets, which have already been determined to have or to lack the property in question. The model trainer 340 applies the trained machine-learning model to the features of the validation set to quantify the accuracy of the machine-learning model. Common metrics applied in accuracy measurement include: Precision=TP/(TP+FP) and Recall=TP/(TP+FN), where precision is how many the machine-learning model 135 correctly predicted (TP or true positives) out of the total it predicted (TP+FP or false positives), and recall is how many the machine-learning model 135 correctly predicted (TP) out of the total number of features that did have the property in question (TP+FN or false negatives). The F score (F-score=2×PR/(P+R)) unifies precision and recall into a single measure. In one embodiment, the model trainer 340 iteratively re-trains the machine-learning model until the occurrence of a stopping condition, such as the accuracy measurement indication that the model is sufficiently accurate, or a number of training rounds having taken place.

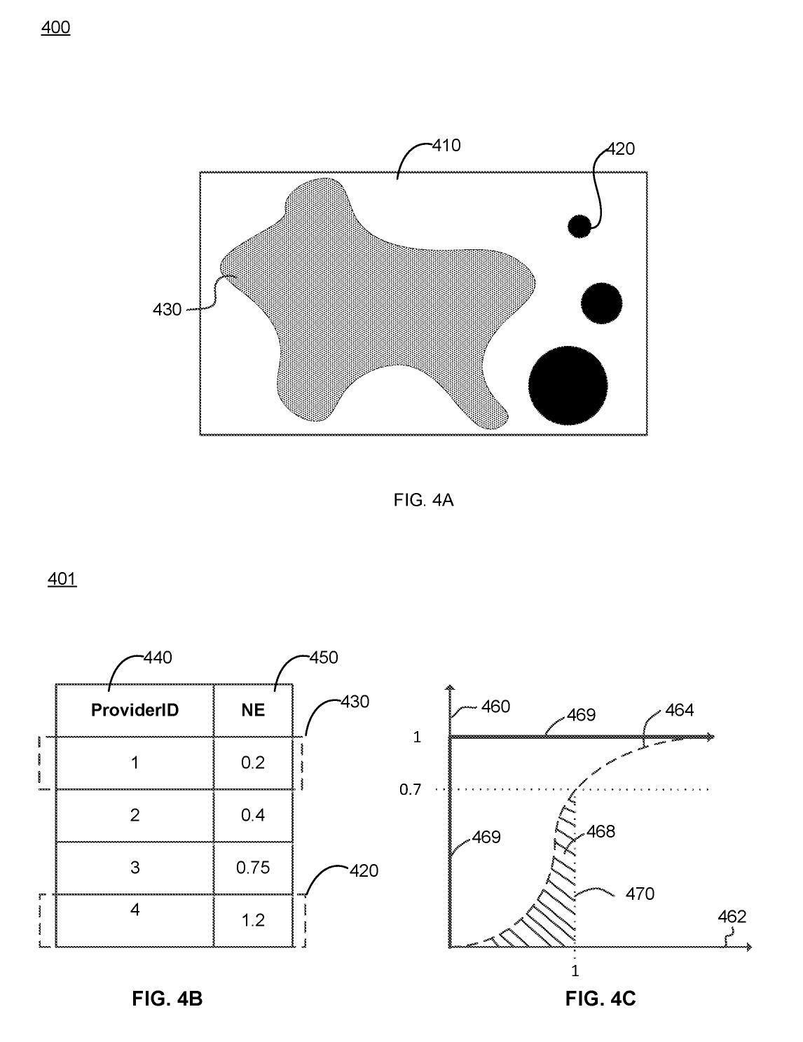

FIG. 4A illustrates a relative percentage, in terms of number of content items, of content providers 120 in a population 410 of content providers 120 in accordance with an embodiment of the invention. In FIG. 4A the population of content providers 410 comprises a content provider A 420 and a content provider B 430. As depicted in FIG. 4A, the relative size content provider B 430 is significantly larger than that of content provider A. Thus, the value of an aggregate performance metric associated with the population of content providers 410 is dominated by the performance of content provider B 430.

In an example embodiment where content provider B 430 is a large department store (e.g., TARGET) while the content provider A 420 is local T-shirt vendor, the relative area of the of the two content providers 420 and 430 is proportional to the number of content items uploaded by the respective content providers. In example depicted in conjunction with FIG. 4A, content provider 430 accounts for approximately 60% of the area of the population 410 while content provider 420 accounts for approximately 10% of the total area of population 410. Conventionally, an aggregate measure of the performance of the population of content providers 410 is an average of the NPM of each individual content-user pair. That is, a conventional aggregate measure of performance is a measure of how users of the online system 110 interact with a content item associated with a content provider 120. Thus, a conventional calculation of performance as determined by aggregating the performance of the machine-learning model for all content providers 120 in the population 410 would obscure the performance of the individual content providers 120 in a population of content providers 410. Therefore, in the example above, the performance of the machine-learning model for the local T-shirt vendor 420 would be obscured by the performance of the machine-learning model for the large retailer.

FIG. 4B illustrates a mapping table 401 generated by ranking the individual content providers in FIG. 4A by NE. The mapping table depicted in FIG. 4B includes a column of providerIDs 440 and a column of NE comprising NE values associated with the content providers 120 in the population of content providers 410. In one or more embodiments, the content providers 120 included in the generated mapping table are sorted by an indicator of performance (e.g., NE). For example, in FIG. 4B the content provider A 420 maps to providerID 4 and a NE of 0.2 and the content provider 420 maps to providerID 4 and a NE of 1.2. Here, the mapping table is generated by mapping the content providers 120 in a population 410 to a table and sorting the mapped content providers 410 by a NE associated with the content provider 120 in the population 410. The generation of a mapping table allows a content provider 120 to gain insight into the performance of the machine-learning model for each individual content provider 120 in a population of content providers 410. Thus, the use of sorting by NE represents an improvement over conventional methods of optimizing a machine-learning model.

FIG. 4C illustrates a graph of the performance of the distribution of the normalized performance metric illustrated in FIG. 4B, in accordance with an embodiment. In FIG. 4C, the vertical axis 460 is the cumulative probability of an interaction per content provider 120 and the horizontal axis 462 represents a metric representing a measure of normalized performance. The curve 464 represents the cumulative density function (CDF) of the distribution of a per-content-provider performance. The shaded area 468 below the curve 464 and to the left of the dotted line 470 indicating a NE value of 1 represents the degree of the performance gain of those content providers who have a performance better than the baseline. FIG. 4C also includes curve 469 which indicates the performance of a machine-learning model which perfectly predicts the performance of content providers 120 in the population of content providers 410. In fact, if the curve 464 represented the performance of a machine-learning model which perfectly predicted the performance of population 410, it would be the same as curve 469.

In the embodiment depicted in FIG. 4C, 70% of all content providers 120 in the population of content providers 410 have an NE less than 1. Hence, the graph depicted in FIG. 4C illustrates an aggregate performance metric indicating that 70% of all content providers 120 in the population of content providers 410 are performing better than the baseline performance metric. Returning once again to the example embodiment illustrated by FIG. 4C, if the area 468 is 10% of the area under the curve 469, FIG. 4C illustrates that the content providers 120 in the population of content providers 410 are achieving 10% relative performance of the performance indicated by curve 469. Hence, by sorting the population of content providers 410 by a NE the online system 110 facilitates the identification of both fine-grained performance criteria for a machine-learning model associated with the population 410 of content providers 120 as well as aggregate performance criteria. In practice, performance metrics illustrated by area 468 is used to improve the performance of a model above that of a baseline performance metric and determine a degree of the improvement over the normalized performance metric.

In some embodiments, the dotted lines represent NE of 0.8 and a cumulative probability less than 1 and the online system 110 determines that a slight change to a machine-learning model resulting in a negligible change in the aggregate NPM associated with the population 410 results in a significant change in a machine-learning model's NPM associated with individual content providers 120 in the population 410. For example, a slight change to a machine-learning model may result in a 20% improvement in the NE associated with one or more content providers 120 in the population 410. Typically, the dotted lines may represent a NE at any more restrictive number (e.g., 0.8 or 0.5). In still other embodiments, the horizontal axis 462 can be generalized to the machine learning models based on regression and the normalized performance metric is an R-squared value.

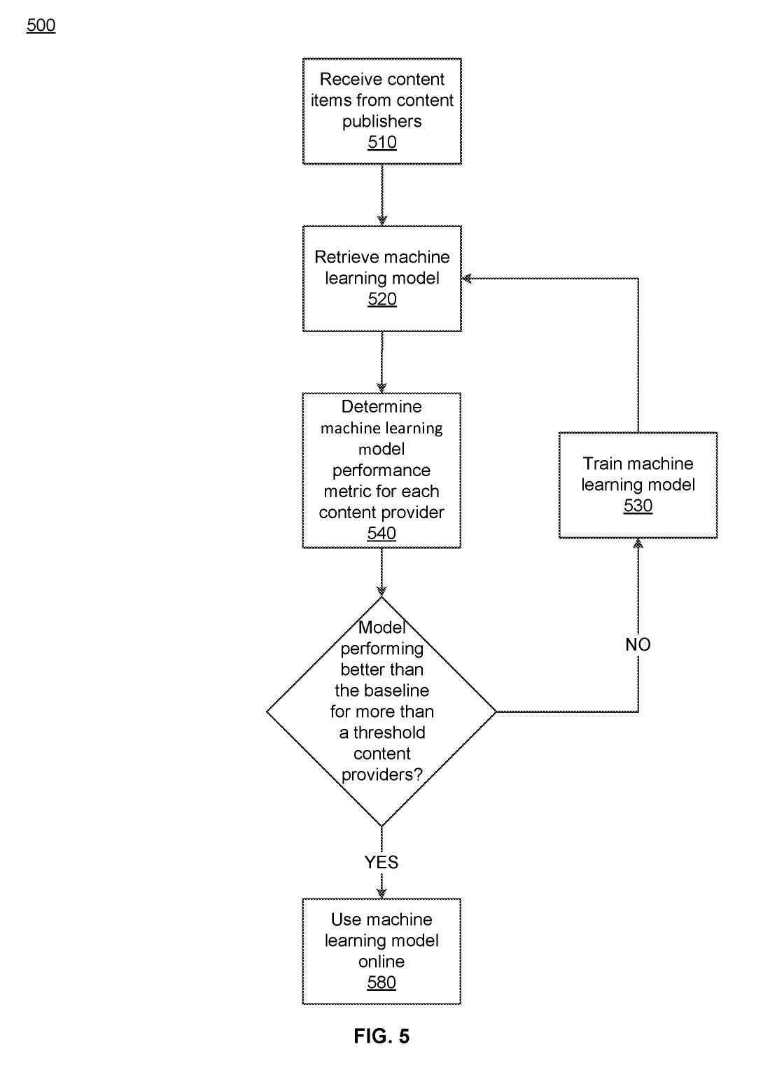

FIG. 5 is a flowchart illustrating operations performed by the online system 110 in order to optimize a machine-learning model performance for one content provider 120. The online system 110 receives 510 one or more content items the content provider 120. In various embodiments, the received content item may be associated with targeting information including demographic (e.g., age, gender, income) to whom the content item is targeted. The online system 110 receives interactions between the users and the one or more received content items. The online system 110 stores the received interactions. The online system 110 retrieves 520 a machine-learning model configured to predict the likelihood of a user interaction for a content provided by a content provider 120. As described above in conjunction with FIG. 2, the machine-learning model may be retrieved 520 from the machine-learning model store 230.

The online system 110 determines 540 machine-learning model performance metric for each of a plurality of content providers 120. In various embodiments, the machine-learning model performance is the NE of the model with respect to a content provider 120. Here, minimizing the NE of a machine-learning model is akin to increasing the accuracy of the machine-learning model with respect to the content provider 120. Determining model performance is further described above in conjunction with FIG. 3. The online system 110 determines a number of content providers for which the model performs better than the baseline model. In an embodiment, the online system 110 determines a fraction or a percentage of the content providers for which the model performs better than the baseline model.

Responsive to determining that model performance metric is indicative of performance better than a baseline performance metric for more than a threshold number of content providers from the plurality of content providers, the machine-learning model is approved for use by the online system. Alternatively, if the online system 110 determines that the machine-learning model is performing worse than the baseline model for more than a threshold number of content providers 120, the model is rejected for use by the online system. Accordingly, the model is retrained 530 using additional interaction data and stored in the machine-learning model store 230 to be evaluated again. In an embodiment, the online system 140 iteratively performs these steps until the retrieved machine-learning model 530 has a performance metric indicative of a performance better than the baseline metric associated with the content provider 120.

### Alternative Embodiments

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
receiving, by an online system, content items from a plurality of content providers;
sending the received content items to one or more client devices associated with users of the online system;
storing information describing user interactions with the content items;
retrieving a machine-learning model configured to predict a score value associated with a user presented with a content item;
determining a baseline performance metric for predicting the score value based on stored user interactions;
for each of the plurality of content providers, performing the steps of:
evaluating a normalized performance metric indicative of the performance of the model for the content provider;
comparing the normalized performance metric for the content provider with the baseline performance metric; and
determining whether the machine-learning model performs better than the baseline performance metric for the content provider;
determining an aggregate normalized performance metric based on the comparison of the normalized performance metric with the baseline performance metric for the plurality of content providers; and
approving the model for use in an online system responsive to the aggregate normalized performance metric exceeding a threshold value.

2. The method of claim 1, wherein the machine learning model is configured to perform binary classification.

3. The method of claim 2, wherein the normalized performance metric is a normalized entropy of the model.

4. The method of claim 1, wherein the machine learning model is a regression based model.

5. The method of claim 4, wherein the normalized performance metric is an r-squared coefficient.

6. The method of claim 1, wherein the aggregate normalized performance metric determines a fraction of the plurality of content providers for which the machine-learning model performs better than the baseline performance metric.

7. The method of claim 1, wherein the aggregate normalized performance metric determines an aggregate value based on improvement of the normalized performance metric over the baseline performance metric for at least a subset of the plurality of content providers.

8. The method of claim 1 further comprises:
rejecting the model for use in the online system responsive to the model performance exceeding a baseline model performance for less than a threshold number of content providers from a total number of content providers.

9. The method of claim 8, further comprising:
responsive to rejecting the machine-learning model, retraining the machine-learning model.

10. The method of claim 1, wherein the model performance metric is a log-loss measure of accuracy wherein the log-loss measure describes an accuracy with which the model can predict a user interaction with a content item associated with the content provider.

11. The method of claim 1, wherein the baseline performance metric is indicative of a likelihood of a user performing a user interaction of a particular interaction type determined based on past user interactions.

12. The method of claim 1 wherein determining that the machine-learning model performs better than the baseline performance metric comprises determining that a normalized entropy associated with the model is greater than a threshold value.

13. A non-transitory computer readable storage medium storing instructions for:
receiving, by an online system, content items from a plurality of content providers;
sending the received content items to one or more client devices associated with users of the online system;
storing information describing user interactions with the content items;
retrieving a machine-learning model configured to predict a score value associated with a user presented with a content item;
determining a baseline performance metric for predicting the score value based on stored user interactions;
for each of the plurality of content providers, performing the steps of:
evaluating a normalized performance metric indicative of the performance of the model for the content provider;
comparing the normalized performance metric for the content provider with the baseline performance metric; and
determining whether the machine-learning model performs better than the baseline performance metric for the content provider;
determining an aggregate normalized performance metric based on the comparison of the normalized performance metric with the baseline performance metric for the plurality of content providers; and
approving the model for use in an online system responsive to the aggregate normalized performance metric exceeding a threshold value.

14. The non-transitory computer readable storage medium of claim 13, wherein the stored instructions are further for:
rejecting the model for use in the online system responsive to the model performance exceeding the baseline model performance for less than a threshold number of content providers from a total number of content providers.

15. The non-transitory computer readable storage medium of claim 14, wherein the stored instructions are further for:
responsive to rejecting the machine-learning model, retraining the machine-learning model.

16. The non-transitory computer readable storage medium of claim 13, wherein the model performance metric is a log-loss measure of accuracy wherein the log-loss measure describes an accuracy with which the model can predict a user interaction with a content item associated with the content provider.

17. The non-transitory computer readable storage medium of claim 13, wherein the baseline performance metric is indicative of a likelihood of a user performing a user interaction of a particular interaction type determined based on past user interactions.

18. The non-transitory computer readable storage medium of claim 13, wherein determining that the machine-learning model performs better than the baseline performance metric comprises determining that a normalized entropy associated with the model is greater than a threshold value.

19. The non-transitory computer readable storage medium of claim 13, wherein the machine learning model is configured to perform binary classification and the normalized performance metric is a normalized entropy of the model.

20. The non-transitory computer readable storage medium of claim 13, wherein the machine learning model is a regression based model and the normalized performance metric is an r-squared coefficient.
